(19) United States
(12) Patent Application Publication
(10) Pub. No.: US 2011/0215917 A1
(43) Pub. Date: Sep. 8, 2011

(54) SYSTEM AND METHOD FOR COMMUNICATING A SIGNAL TO EMIT A VISUAL DISPLAY AT DIFFERENT FRAME RATES

(75) Inventors: TIMOTHY D. BOLDUC, WESTFIELD, IN (US); PAUL T. WAGNER, KOKOMO, IN (US); BRIAN L. BICKFORD, KOKOMO, IN (US)

(73) Assignee: DELPHI TECHNOLOGIES, INC., TROY, MI (US)

(21) Appl. No.: 12/719,427

(22) Filed: Mar. 8, 2010

(51) Int. Cl. B60Q 1/00; H04L 27/00

(52) U.S. Cl. 340/438

(57) ABSTRACT

A receiver system integrated with a vehicle, transmitter system, and methods thereof are provided. The receiver system includes an antenna configured to receive the signal, and a receiver device in communication with the antenna, the receiver device is configured to process the received signal, wherein the receiver device is further configured to determine if the vehicle is in one of a first state and a second state. The receiver system further includes a display in communication with the receiver device, wherein the display is configured to emit a visual display as a function of the received signal, and the display emits the visual display at a first frame rate when the receiver device determines that the vehicle is in the first state, and the display emits the visual display at a second frame rate when the receiver device determines that the vehicle is in the second state.

### FIELD OF THE INVENTION

The present invention generally relates to a system and method for communicating a signal, and more particularly, a system and method for communicating a signal to emit a visual display at different frame rates.

### BACKGROUND OF THE INVENTION

Numerous digital delivery mechanisms have been developed for transmitting audio and visual material between two points. Generally, data compression and bandwidth management features have matured to a level where commercially viable business models have been created for the delivery of this content over wireless channels (e.g., VCAST™, SPRINT™ POWERVISION™, etc.). Virtually all of these solutions attempt to solve the same problem, which is how to optimize encoding and transmission of source content to maximize a perceived rendered quality at an end point (e.g., laptop, cell phone, car screen, etc.). In many bidirectional communication systems, numerous tradeoffs can typically be made in near real-time in an effort to optimize the streamed viewing experience as available bandwidth changes.

### SUMMARY OF THE INVENTION

According to one aspect of the present invention, a receiver system is integrated with a vehicle, wherein the receiver system is configured to receive a signal that is transmitted from a transmitter at a frame rate, and includes an antenna configured to receive the signal. The receiver system further includes a receiver device in communication with the antenna, the receiver device being configured to process the received signal, wherein the receiver device is further configured to determine if the vehicle is in one of a first state and a second state. Additionally, the receiver system includes a display in communication with the receiver device, wherein the display is configured to emit a visual display as a function of the received signal, and the display emits the visual display at a first frame rate when the receiver device determines that the vehicle is in the first state, and the display emits the visual display at a second frame rate when the receiver device determines that the vehicle is in the second state.

According to another aspect of the present invention, a transmitter system is configured to communicate with a receiver system, wherein the transmitter system is configured to determine if a vehicle is one of in a first state and a second state. The transmitter system further includes an antenna, and a transmitter device in communication with the antenna, the transmitter device being configured to transmit a signal at a first frame rate when it is determined that the vehicle is in the first state, and transmit the signal at a second frame rate when it is determined that the vehicle is in the second state, wherein the first frame rate is greater than the second frame rate.

According to yet another aspect of the present invention, a method of communicating a signal having a frame rate is provided, wherein the method includes the steps of receiving a transmitted signal, determining if a vehicle is in a first state, determining if the vehicle is in a second state, emitting a visual display corresponding to the received signal at a first frame rate when it is determined that the vehicle is in the first state, and emitting a visual display corresponding to the received signal at a second frame rate when it is determined that the vehicle is in the second state, wherein the first frame rate is greater than the second frame rate.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is an environmental view of a communication system, in accordance with one embodiment of the present invention;

FIG. 2 is a schematic diagram of a communication system having a receiver system and a transmitter system, in accordance with one embodiment of the present invention;

FIG. 3 is a flowchart of a method of communicating a signal having a frame rate, in accordance with one embodiment of the present invention; and

FIG. 4 is a flowchart of a method of communicating a signal having a frame rate, in accordance with one embodiment of the present invention.

### DESCRIPTION OF EMBODIMENTS

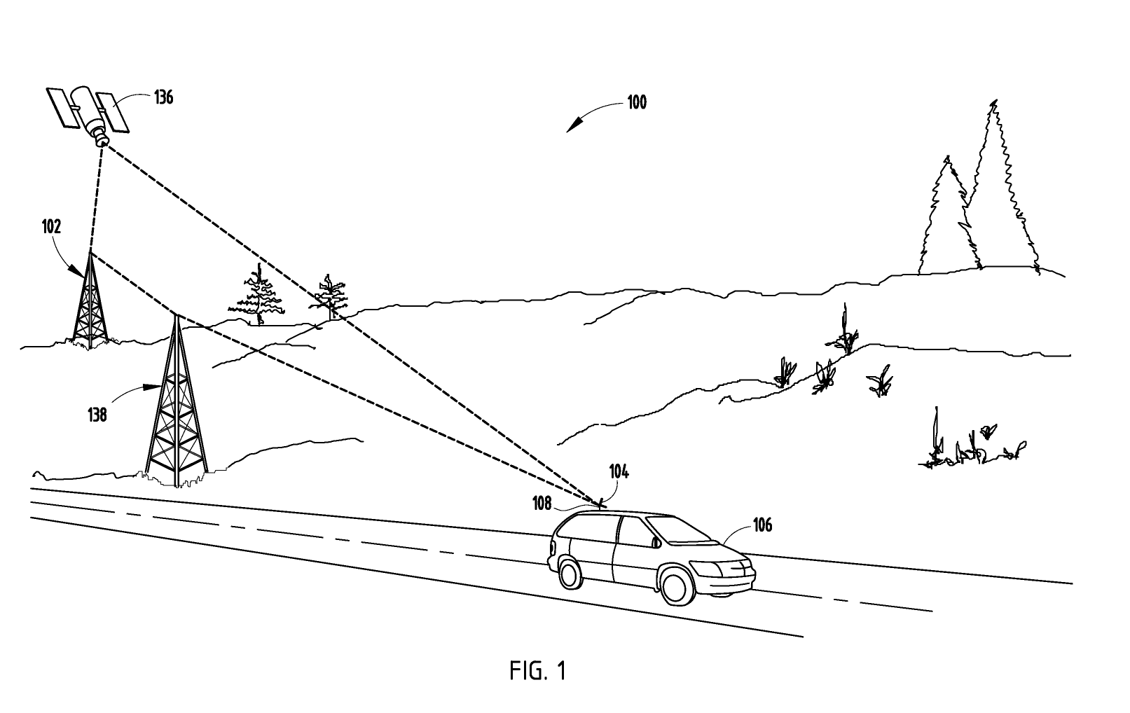

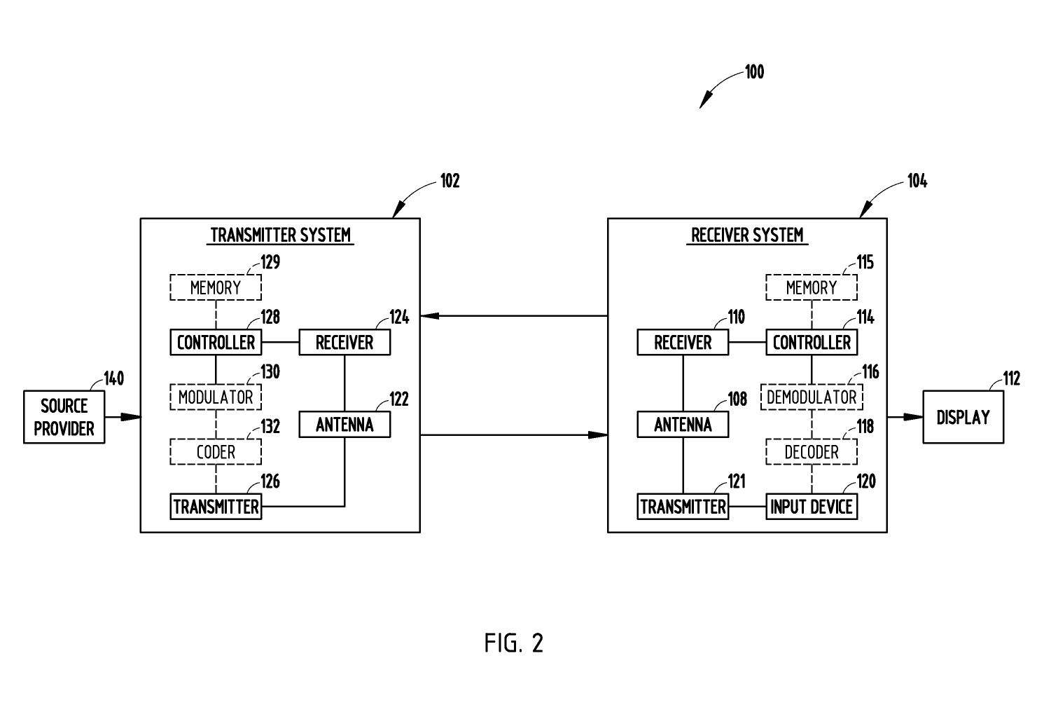

With respect to FIGS. 1 and 2, a communication system is generally shown in FIG. 1 at reference identifier 100, according to one embodiment. The communication system 100 can include a transmitter system, generally indicated at reference identifier 102, and a receiver system, generally indicated at reference identifier 104. Typically, the transmitter system 102 and the receiver system 104 can be in communication with one another, such that the transmitter system 102 transmits a signal that can be received by the receiver system 104, and the receiver system 104 can emit a visual display at a dynamically altered frame rate, as described in greater detail herein.

According to one embodiment, a receiver system 104 is integrated with a vehicle 106 (FIG. 1), wherein the receiver system 104 is configured to receive a signal that is transmitted from the transmitter system 102 and has a frame rate. The receiver system 104 can include an antenna 108 configured to receive the signal, and a receiver device 110 (FIG. 2) in communication with the antenna 108. The receiver device 110 can be configured to process the received signal, wherein the receiver device 110 can be further configured to determine whether the vehicle 106 is in a first state or second state.

As exemplary illustrated in FIG. 2, the receiver system 104 can further include a display 112 in communication with the receiver device 110, wherein the display 112 can be configured to emit a visual display as a function of the received signal. It should be appreciated by those skilled in the art that the display 112 can be part of the receiver system 104 or a device separate from, but in communication with, the receiver system 104. The display 112 can emit the visual display at a first frame rate when the receiver device 110 determines that the vehicle 106 is in the first state, and the display 112 can emit the visual display at a second frame rate when the receiver device 110 determines that the vehicle 106 is in the second state.

Typically, the first frame rate is a greater frame rate than the second frame rate. Thus, a visual output emitted by the display 112 can be of higher quality when the first frame rate is utilized, as compared to when the second frame rate is utilized for emitting the visual output by the display 112. According to one embodiment, emitting the visual display at a second frame rate results in the visual display not being a video display, since the vehicle 106 is in motion, the driver of the vehicle 106 can be distracted or gazing approximately in a direction of the display 112, the like, or a combination thereof, and the display 112 can be positioned within the vehicle 106 to be viewed by a driver of the vehicle 106 when in a normal operating position. For purposes of explanation and not limitation, in such an embodiment, the display 112 can emit a slow cadence slide show when the second frame rate is utilized.

According to one embodiment, the vehicle 106 can be substantially stationary when the receiver device 110 determines that the vehicle 106 is in a first state, and the vehicle 106 can be non-stationary when the receiver device 110 determines that the vehicle 106 is in the second state. By way of explanation and not limitation, the receiver system 104 can dynamically determine if the vehicle 106 is substantially stationary if the vehicle is in PARK (e.g., a transmission system of the vehicle 106 is not in gear), the vehicle 106 is moving less than a speed threshold (e.g., less than five miles per hour (5 mph)), an engine of the vehicle 106 is not supplying power while another power source (e.g., a battery) is supplying electrical power to the receiver system 104) the like, or a combination thereof.

Additionally or alternatively, the driver of the vehicle 106 can be determined to be substantially not distracted, not gazing approximately in a direction of the display 112 for a predetermined period of time, the like, or a combination thereof, when the receiver device 110 determines that the vehicle 106 is in the first state, and the driver of the vehicle 106 can be determined to be distracted, gazing approximately in the direction of the display 112 for a predetermined period of time, the like, or a combination thereof, when the receiver device 110 determines that the vehicle 106 is in the second state. In such an embodiment, a driver distraction detection device or driver gaze detection device can be utilized for determining the driver gaze. Exemplary driver detection devices or driver gaze devices are described in U.S. Patent Application Publication No. 2009/0034801 entitled “SYSTEM AND METHOD OF AWARENESS DETECTION,” U.S. Patent Application Publication No. 2006/0251297 entitled “SYSTEM AND METHOD TO DETERMINE AWARENESS,” U.S. Patent Application Publication No. 2009/0123031 entitled “AWARENESS DETECTION SYSTEM AND METHOD,” U.S. Patent Application Publication No. 2006/0092401 entitled “ACTIVELY-ILLUMINATING OPTICAL SENSING SYSTEM FOR AN AUTOMOBILE,” U.S. Pat. No. 7,364,301 entitled “VEHICULAR OPTICAL SYSTEM,” and U.S. Pat. No. 6,989,754 entitled “TARGET AWARENESS DETERMINATION SYSTEM AND METHOD,” the references are hereby being incorporated herein by reference in their entirety.

According to one embodiment, the receiver device 110 can communicate with the transmitter system 102 when the vehicle 106 is in the second state, such that the transmitter system 102 transmits the signal at the second frame rate, as described in greater detail herein. In such an embodiment, a bandwidth of the transmitted signal can be reduced when the transmitted signal is transmitted at the second frame rate.

According to an additional or alternative embodiment, the receiver device 110 can determine when the vehicle 106 is in the second state, and the display 112 can emit the visual display at a second frame rate. Typically, the receiver device 110 can discard (e.g., delete without further processing) un-used data of the received signal. In such an embodiment, the bandwidth of the transmitted signal remains the same, such that the transmitted signal is transmitted at the first frame rate so that the display 112 can emit the visual display of the first frame rate when it is determined that the vehicle 106 is in the first state, and the display 112 can emit the visual display at the second frame rate when it is determined that the vehicle 106 is in a second state, at which time the un-used data received in the transmitted signal can be discarded.

Typically, the display 112 can be adapted to be visible to a driver of the vehicle 106 when the driver is in a normal operating position. For purposes of limitation and not limitation, the display 112 can be integrated with a dash board, such as, but not limited to, a navigation system display, removably attached to the dash board, other suitable interior location, be incorporated into a cellular or satellite device that is used within an interior of the vehicle 106, the like, or a combination thereof. Additionally or alternatively, the antenna 108, the receiver device 110, or a combination thereof, can be a cellular device, a satellite device, the like, or a combination thereof, and are further configured to communicate with the display 112 via a secondary network. Exemplary secondary networks are can be, but are not limited to, BLUETOOTH™, Wi-Fi, other suitable wireless networks, universal serial port (USB), firewall, other suitable wired networks, the like, or a combination thereof.

According to one embodiment, the receiver system 104 can include one or more other electronic hardware components and/or software components. Exemplary components can be a controller 114 that can be configured to process one or more executable software routines, a memory device 115 configured to store one or more executable software routines, a de-modulator 116 configured to demodulate the received signal, a decoder 118 configured to decode the received signal, an input device 120 configured to receive an input from a user of the receiver system 104, and a transmitter device 121 configured to communicate with the transmitter system 102. For purposes of explanation and not limitation, the memory device 115 can be volatile memory, non-volatile memory, or a combination thereof, and the input device 120 can be a keypad, a keyboard, a microphone, a virtual keypad, a virtual keyboard, a touch screen, other suitable hardware or virtual buttons, the like, or a combination thereof. However, it should be appreciated by those skilled in the art that the receiver system 104 can include additional or alternative hardware components and/or software components.

According to one embodiment, the transmitter system 102 can be configured to communicate with the receiver system 104, wherein the receiver system 104 can be configured to determine if the vehicle 106 is in the first state or in the second state. The transmitter system 102 can include an antenna 122, and a receiver device 124 in communication with the antenna 122, wherein the receiver device 124 is configured to communicate with the receiver system 104. The transmitter system 102 can further include a transmitter device 126 in communication with the receiver device 124, wherein the transmitter device 126 can be configured to transmit a signal at a first frame rate when the receiver device 124 receives a signal from the receiver system 104 corresponding to the vehicle 106 being substantially stationary. The transmitter device 126 can further be configured to transmit the signal at a second frame rate when the receiver device 124 receives a signal from the receiver system 102 corresponding to the vehicle 106 being non-stationary.

Additionally or alternatively, the transmitter system 102 determines the state of the vehicle 102 without receiving a signal from the receiver system 104. In such an embodiment, the communication system 100 can utilize a device or system, such as, but not limited to, an e911 system, and configured to detect a state of the vehicle 106. Typically, such a device or system can be configured to determine a position and/or velocity of the vehicle 106, such that the frame rate of the transmission is dynamically altered without the transmitter system 102 receiving a signal from the receiver system 104. Thus, the receiver system 104 can be configured to determine the state of the vehicle 106 and communicate the vehicle state to the transmitter system 102, the transmitter system 102 can be configured to determine the state of the vehicle 106, or a combination thereof.

Typically, the first frame rate is greater than the second frame rate. Further, the bandwidth of the transmitted signal can be reduced when the transmitted signal is transmitted at the second frame rate. According to one embodiment, there can be different classifications of the second state. By way of explanation and not limitation, a first classification of the second state can be when the receiver system 104 determines that the vehicle 106 is potentially temporarily (e.g., a short duration) substantially stationary, such as, but not limited to, when the vehicle is below a speed threshold but a transmission of the vehicle 106 is still in DRIVE or a gear other than PARK. A second classification of the second state can be when the receiver system 104 determines that the vehicle 106 is potentially substantially stationary for a longer duration, such as, but not limited to, when the vehicle 106 is in PARK or when an engine of the vehicle 106 is not supplying power, while another power source (e.g., a battery) is supplying electrical power to the receiver system 104.

In such an embodiment, when the receiver system 104 determines that the vehicle 106 is substantially stationary under the first classification, the receiver system 106 may not communicate the determination to the transmitter system 102, and emit the visual display at the first frame rate or emit the visual display at the second frame rate while discarding the un-used data. However, if the receiver system 104 determines that the vehicle 106 is substantially stationary under the second classification, the receiver system 106 may communicate the determination to the transmitter system 102 so that the signal is transmitted at the second frame rate.

According to one embodiment, the transmitter system 102 can include one or more other electronic hardware components or software components, such as, but not limited to, a controller 128 that can be configured to process one or more executable software routines, a memory device 129 configured to store one or more executable software routines, a modulator 130 configured to modulate the signal prior to transmission, and a coder 132 to code the signal prior to transmission. For purposes of explanation and not limitation, the memory device 129 can be volatile memory, non-volatile memory, or a combination thereof. However, it should be appreciated by those skilled in the art that the transmitter system 102 can include additional or alternative hardware components and/or software components.

As exemplary illustrated in FIG. 1, the transmitter system 102 can be in communication with the receiver system 104 via a satellite 136, an RF transmitter 138, the like, or a combination thereof. In one embodiment, the RF transmitter 138 can be a terrestrial repeater configured to re-transmit the signal communicated by the transmitter system 102. Typically, a source provider 140 (FIG. 2) supplies content to be communicated from the transmitter system 102 to the receiver system 104.

For purposes of explanation and not limitation, the communication system 100 can make use of both intraframe and interframe correlations to produce high compression ratios. Intraframe encoded content typically does not rely upon any other a priori or post priori frame information. These frames can be referred to as “I” frames, and they can exist as self-decodeable frame segments within a larger aggregate video stream. Typically, non-“I” frames can make use of additional information from other frames in the stream, and thus, they can exhibit higher compression efficiency, but they can also exhibit negative attributes associated with difficulty in trick frame seeks and initial stream rendering start points. Thus, although “I” frames are typically not as compressed as other frame types, they can exist periodically in video streams at an approximately uniform cadence to reduce “tune time” issues that otherwise may be objectionable to a viewer. In the largely deployed Moving Pictures Expert Group 2 (MPEG2) standard, many/most satellite and Digital Video Disc (DVD) content is compressed using a “Group of Pictures” (GOP) structure that places an “I” frame into the stream approximately every one-half of a second (0.5 s). Other codecs like VC-1 and H.264 can allow “I” frames to be placed in the stream in more of a dynamic way, but the cadence of these “I” frames is typically sub two-seconds (2 s) within the stream.

Thus, a unicast video stream can be programmatically inspected in real time by a content server to identify the “I” frame data. These “I” frames could then be selectively transmitted to the rendering device to match the frame rate use rules enforced by the renderer. In other words, if the vehicle renderer has requested a stream that does not exceed one (1) frame per five (5) seconds, the video server can “scan” the full stream and only send the “I” frames which are at least five (5) seconds apart in the stream. This method can produce a reduced complexity way of meeting use case requirements, and it can dramatically reduce the wireless bandwidth requirements, for the transmittal of this content. As an example, thirty frames per second (30 fps) content can be compressed and sent at common intermediate format (CIF) resolution using best of breed codecs using about five hundred kilobits per second (500 kbps). At this quality level, “I” frames typically require about one hundred kilobits per frame (100 kb/frame). Thus at a 0.2 fps rate, this “I” frame only substream can require about twenty kilobits per second (20 kbps).

The video content server can elect to transcode the content, but transcoding typically requires orders of magnitude more complexity, and thus, would require additional computational infrastructure to manage many simultaneous transcodes. The communication system 100 and methods directed herein can produce a very similar result at a much lower complexity and cost, according to one embodiment.

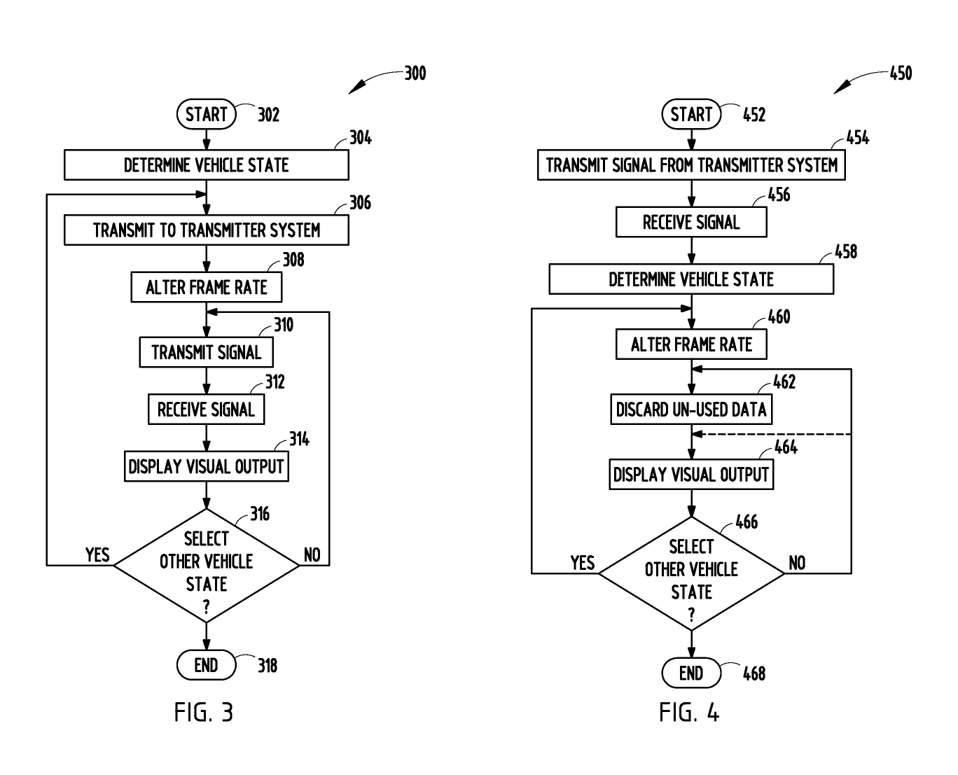

With respect to FIGS. 1-3, a method of communicating a signal having a frame rate is generally shown in FIG. 3 at reference identifier 300, according to one embodiment. The method 300 starts at step 302, and proceeds to step 304, wherein a vehicle 106 state is determined. Typically, the vehicle 106 state that is determined can be the first state when the vehicle 106 is substantially stationary, the driver of the vehicle 106 is substantially not distracted, not gazing in approximately the direction of the display 112, the like, or a combination thereof, and can be the second state when the vehicle 106 is non-stationary, the driver of the vehicle 106 is distracted, gazing approximately in the direction of the display 112, the like, or a combination thereof. At step 306, the vehicle 106 state is transmitted to the transmitter system 102, according to one embodiment.

The method 300 can then proceed from step 304 or step 306 to step 308, wherein the frame rate is altered, and at step 310 the signal is transmitted by the transmitter system 102. At step 312, the signal can be received by the receiver system 104, and at step 314, the visual display or output is displayed. Typically, the visual display is outputted by the display 112. At decision step 316 it is determined if another vehicle 106 state is to be selected. If it is determined at decision step 316 that another vehicle 106 state is to be selected, then the method 300 returns to step 306, wherein the vehicle 106 state is transmitted to the transmitter system 102. However, if it is determined at decision step 316 that another vehicle 106 state is not to be selected, then the method 300 returns to step 310, wherein the signal is continued to be transmitted by the transmitter system 102. The method 300 can then end at step 318.

According to an additional or alternative embodiment, in regards to FIGS. 1, 2, and 4, a method of communicating a signal having a frame rate is generally shown in FIG. 4 at reference identifier 450. The method 450 starts at step 452 and proceeds to step 454, wherein a signal is transmitted from the transmitter system 102. At step 456 the signal is received by the receiver system 104, and at step 458, a vehicle 106 state is determined. Typically, the vehicle 106 state that is determined can be the first state when the vehicle 106 is substantially stationary, and can be the second state when the vehicle 106 is non-stationary.

The method 450 then proceeds to step 460, wherein the frame rate is altered. At step 462, any un-used data is discarded, such as when the second or reduced frame rate is used, as compared to the transmitted signal being transmitted at a higher frame rate. At step 464, the visual output is displayed. At decision step 466 it is determined if another vehicle 106 state is to be selected. If it is determined at decision step 466 that another vehicle 106 state is to be selected, then the method 450 returns to step 460, wherein the frame rate can be altered based upon the newly selected vehicle 106 state. However, if it is determined at decision step 466 that another vehicle 106 state is not to be selected, then the method 450 can return to step 462 to discard un-used data if the second frame rate is being utilized or step 464 if the first frame rate is being utilized. The method 450 can then end at step 468.

It should be appreciated by those skilled in the art that a least a portion of the steps of method 450 can be combined with at least a portion of the steps of method 300, such that a combined method further comprises one or more steps of determining a classification of a second state of the vehicle 106, as described in greater detail above.

Advantageously, the communication system 100 and methods 300, 450 allow for a display 112 to be within a field of view of a driver of the vehicle 106 when the driver is in a normal operating position, since the display 112 emits the visual display at a lower frame rate when the vehicle 106 is not-stationary. Further, the display 112 emits the visual display at a higher frame rate when the vehicle 106 is substantially stationary, such that the viewer receives a more high quality visual output then when the reduced frame rate is utilized. It should be appreciated by those skilled in the art that additional or alternative advantages may be present based upon the communication system 100 and the methods 300, 450. Further, it should be appreciated by those skilled in the art that the above-described components and steps can be combined in additional or alternative ways not explicitly described herein.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A receiver system integrated with a vehicle, wherein said receiver system is configured to receive a signal that is transmitted from a transmitter system at a frame rate, and said receiver system comprising:
an antenna configured to receive the signal;
a receiver device in communication with said antenna, said receiver device configured to process the received signal, wherein said receiver device is further configured to determine if the vehicle is in one of a first state and a second state; and
a display in communication with said receiver device, wherein said display is configured to emit a visual display as a function of the received signal, and said display emits said visual display at a first frame rate when said receiver device determines that the vehicle is in said first state, and said display emits said visual display at a second frame rate when said receiver device determines that the vehicle is in said second state.

2. The receiver system of claim 1, wherein said first frame rate is greater than said second frame rate.

3. The receiver system of claim 2, wherein the vehicle is substantially stationary when said receiver device determines the vehicle is in said first state, and the vehicle is non-stationary when said receiver device determines the vehicle is in said second state.

4. The receiver system of claim 2, wherein a driver of the vehicle is at least one of substantially not distracted and not gazing in approximately a direction of said display when said receiver device determines the vehicle is in said first state, and the driver of the vehicle is at least one of distracted and gazing in approximately a direction of said display when said receiver device determines the vehicle is in said second state.

5. The receiver system of claim 2 configured to communicate with the transmitter system when the vehicle is in said second state, such that the transmitter system transmits the signal at said second frame rate.

6. The receiver system of claim 5, wherein a bandwidth of the transmitted signal is reduced when the transmitted signal is transmitted at said second frame rate.

7. The receiver system of claim 1, wherein when said receiver device determines the vehicle is in said second state, said display emits said visual display at said second frame rate, such that said receiver device is configured to discard un-used data of the received signal.

8. The receiver system of claim 1, wherein said antenna and said receiver device are at least one of a cellular device and a satellite device, and are further configured to communicate with said display via a secondary network.

9. A transmitter system configured to communicate with a receiver system, wherein said transmitter system is configured to determine if a vehicle is one of in a first state and a second state, said transmitter system comprising:
an antenna; and
a transmitter device in communication with said antenna, said transmitter device being configured to transmit a signal at a first frame rate when it is determined that the vehicle is in the first state, and transmit said signal at a second frame rate when it is determined that the vehicle is in the second state, wherein said first frame rate is greater than said second frame rate.

10. The transmitter system of claim 9, wherein the vehicle is substantially stationary when the vehicle is in the first state, and the vehicle is non-stationary when the vehicle is in the second state.

11. The transmitter system of claim 9, wherein a driver of the vehicle is at least one of substantially not distracted and not gazing in approximately a direction of a display of the receiver system when the vehicle is in the first state, and the driver of the vehicle is at least one of distracted and gazing in approximately a direction of said display when the vehicle is in the second state.

12. The transmitter system of claim 9, wherein at least one of the receiver system is configured to determine the vehicle state of the vehicle and communicate the state to said transmitter system, and said transmitter system is configured to determine the state of the vehicle.

13. The transmitter system of claim 9, wherein bandwidth of said transmitted signal is reduced when said transmitted signal is transmitted at said second frame rate.

14. A method of communicating a signal having a frame rate, said method comprising the steps of:
receiving a transmitted signal;
determining if a vehicle is in a first state;
determining if said vehicle is in a second state;
emitting a visual display corresponding to said received signal at a first frame rate when it is determined that said vehicle is in said first state; and
emitting a visual display corresponding to said received signal at a second frame rate when it is determined that said vehicle is in said second state, wherein said first frame rate is greater than said second frame rate.

15. The method of claim 14 further comprising the steps of:
communicating from a receiver system to a transmitter system when it is determined that said vehicle is non-stationary; and
transmitting said transmitted signal by said transmitter system to said receiver system at said second frame rate as a function of said transmitter system receiving said communication from said receiver system.

16. The method of claim 14, wherein said vehicle is in said first state when at least one of said vehicle is substantially stationary, a driver of said vehicle is substantially not distracted, and said driver of said vehicle is not gazing in approximately a direction of a display configured to emit said visual display.

17. The method of claim 16, wherein said vehicle is in said second state when at least one of said vehicle is non-stationary, said driver of said vehicle is distracted, and said driver of said vehicle is gazing in approximately said direction of said display.

18. The method of claim 14 further comprising at least one of the steps of:
determining said state of said vehicle by a receiver system, and communicating said determined state by said receiver system to a transmitter system; and
determining said state of said vehicle by said transmitter system.

19. The method of claim 14 further comprising the step of:
discarding un-used data of said received signal when emitting said visual display corresponding to said received signal at said second frame rate.

20. The method of claim 14, wherein an antenna and a receiver device of said receiver system are at least one of a cellular device and a satellite device, and are further configured to communicate with a display via a secondary network.
